(19) United States
(12) Patent Application Publication
(10) Pub. No.: US 2013/0054362 A1
(43) Pub. Date: Feb. 28, 2013

(54) COMPUTER CUSTOMIZATION OF PROVIDED PRODUCTS AND SERVICES

(71) Applicants: Erik Stephen Ross, Charlotte, NC (US); Rushad F. Eduljee, Hockessin, DE (US); Dana B. Goldfarb, Charlotte, NC (US); Brian Kane, Wallingford, PA (US)

(72) Inventors: Erik Stephen Ross, Charlotte, NC (US); Rushad F. Eduljee, Hockessin, DE (US); Dana B. Goldfarb, Charlotte, NC (US); Brian Kane, Wallingford, PA (US)

(73) Assignee: Bank Of America Corporation, Charlotte, NC (US)

(21) Appl. No.: 13/217,317

(22) Filed: Aug. 25, 2011

(51) Int. Cl. G06Q 30/00; G06Q 40/00

(52) U.S. Cl. 705/14.53; 705/35

(57) ABSTRACT

A method, apparatus, computer-readable medium and system are disclosed for providing a computerized algorithm for customizing products and/or services provided to a user. The products and/or services may be related to banking and/or accounts. In some embodiments, a device may access and analyze historical information associated with a user. Based at least in part on the analysis, the device may determine whether the user has an option to customize a product or service, such as terms or conditions associated with a product or service offering. When the user has the option to customize the product/service, the device may transmit a recommendation to the user, where the recommendation comprises a suggested value to be associated with the product/service.

### FIELD

Aspects of the present disclosure relate to customizing a product or service. More specifically, aspects of this disclosure relate to providing products and services that meet a user's needs or preferences.

### BACKGROUND

Improvements in computing technologies have changed the way people interact with one another, as well as how people acquire products and services and conduct business. For example, a user may use a web browser to view a bank statement, to pay a bill, and to apply for a mortgage or loan.

From the perspective of a product/service provider, the provider would like to ensure that users are satisfied with the product or service. For example, if a user is satisfied with the product or service, the user will be more likely to use the product or service again in the future.

Improvements in product/service offerings are needed to ensure that users are satisfied and see continued value in acquiring a given product/service.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure are directed to an apparatus, method, computer readable media, and system for targeting users with one or more product or service offerings. In some embodiments, a computing device may provide a suggestion or recommendation regarding a product or service in which a user might be interested. The suggestion or recommendation may be based on an analysis of historical acquisitions, purchases, spending patterns, (internet) browsing activity, and/or the like.

In some embodiments, a suggested product or service offering may be based at least in part on feedback provided by the user. For example, in some embodiments a user may be asked to fill out, or submit answers to, a survey, or in some other way indicate his/her preferences. In some embodiments, a product/service provider may initially target a subset of a pool of users in terms of discerning the subset's preferences.

In some embodiments, the product/service may relate to banking or finance. For example, an account may be established and the user preferences may relate to one or more terms or conditions to be associated with the account.

Aspects of the embodiments may be provided in at least one computer-readable medium and/or memory storing computer-executable instructions that, when executed by at least on processor, cause a computer or other apparatus to perform one or more of the process steps described herein.

### BRIEF DESCRIPTION OF THE DRAWINGS

The present disclosure is illustrated by way of example and not limited in the accompanying figures in which like reference numerals indicate similar elements.

FIG. 1 illustrates an example computing environment in which various aspects of the disclosure may be implemented.

FIG. 2 illustrates a simplified diagram of a system in which various aspects of the disclosure may be implemented.

FIGS. 3A-3B illustrate an example method suitable for implementing one or more aspects of this disclosure.

### DETAILED DESCRIPTION

In the following description of the various embodiments, reference is made to the accompanying drawings, which form a part hereof, and in which is shown by way of illustration various embodiments in which one or more aspects of the disclosure may be practiced. It is to be understood that other embodiments may be utilized and structural and functional modifications may be made without departing from the scope of the present disclosure.

Various connections between elements are discussed in the following description. These connections are general and, unless specified otherwise, may be direct or indirect, wired or wireless, and this specification is not intended to be limiting in this respect.

In accordance with various aspects of this disclosure, apparatuses, systems, computer readable media, and methods are described for customizing product and service offerings. For illustrative purposes the product/service provider discussed throughout the below description is a bank, and the bank is customizing an account to suit a user/customer/consumer's particular needs or preferences. However, as those skilled in the art will realize, the described aspects of the disclosure are not limited to banking products and services, but may also include other types of products or services.

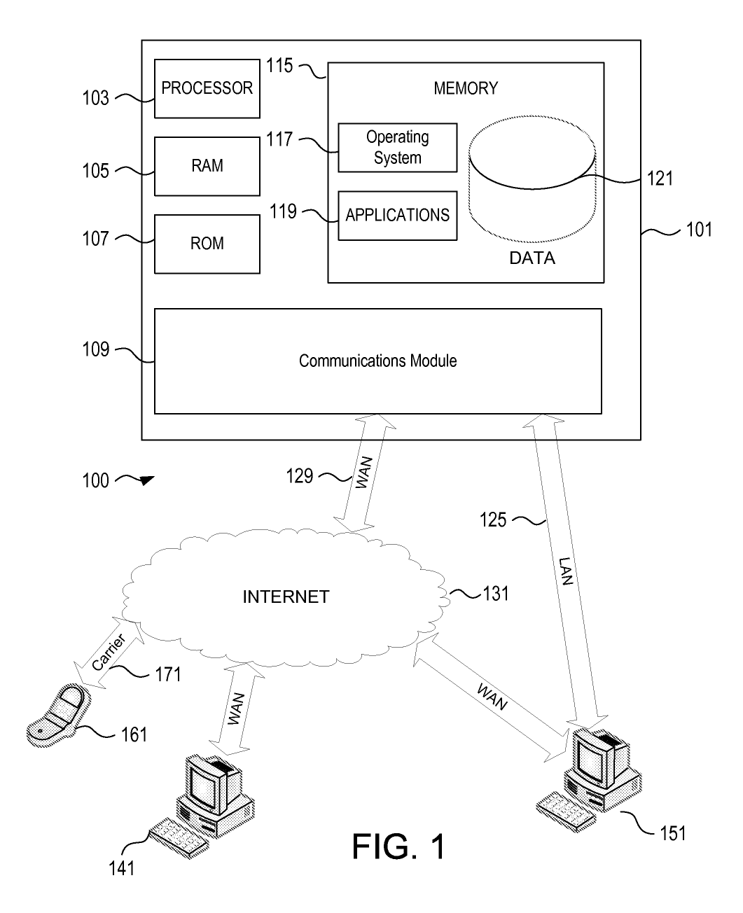

FIG. 1 illustrates an example of a suitable computing system environment 100 that may be used according to one or more illustrative embodiments. The computing system environment 100 is only one example of a suitable computing environment and is not intended to suggest any limitation as to the scope of use or functionality contained in the disclosure. The computing system environment 100 should not be interpreted as having any dependency or requirement relating to any one or combination of components shown in the illustrative computing system environment 100.

The disclosure is operational with numerous other general purpose or special purpose computing system environments or configurations. Examples of well known computing systems, environments, and/or configurations that may be suitable for use with the disclosed embodiments include, but are not limited to, personal computers (PCs), server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

With reference to FIG. 1, the computing system environment 100 may include a computing device 101 wherein the processes discussed herein may be implemented. The computing device 101 may have a processor 103 for controlling overall operation of the computing device 101 and its associated components, including random-access memory (RAM) 105, read-only memory (ROM) 107, communications module 109, and memory 115. Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable instructions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Communication media typically embodies computer readable instructions, data structures, program modules or other data in a modulated data signal such as a carrier wave or other transport mechanism and includes any information delivery media. Modulated data signal includes a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Computing system environment 100 may also include optical scanners (not shown). Exemplary usages include scanning and converting paper documents, e.g., correspondence, receipts, etc. to digital files.

Although not shown, RAM 105 may include one or more applications representing the application data stored in RAM 105 while the computing device is on and corresponding software applications (e.g., software tasks), are running on the computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output.

Software may be stored within memory 115 and/or storage to provide instructions to processor 103 for enabling computing device 101 to perform various functions. For example, memory 115 may store software used by the computing device 101, such as an operating system 117, application programs 119, and an associated database 121. Also, some or all of the computer executable instructions for computing device 101 may be embodied in hardware or firmware.

Computing device 101 may operate in a networked environment supporting connections to one or more remote computing devices, such as computing devices 141, 151, and 161. The computing devices 141, 151, and 161 may be personal computing devices or servers that include many or all of the elements described above relative to the computing device 101. Computing device 161 may be a mobile device communicating over wireless carrier channel 171.

The network connections depicted in FIG. 1 include a local area network (LAN) 125 and a wide area network (WAN) 129, but may also include other networks. When used in a LAN networking environment, computing device 101 may be connected to the LAN 825 through a network interface or adapter in the communications module 109. When used in a WAN networking environment, the computing device 101 may include a modem in the communications module 109 or other means for establishing communications over the WAN 129, such as the Internet 131 or other type of computer network. It will be appreciated that the network connections shown are illustrative and other means of establishing a communications link between the computing devices may be used. Various well-known protocols such as TCP/IP, Ethernet, FTP, HTTP and the like may be used, and the system can be operated in a client-server configuration to permit a user to retrieve web pages from a web-based server. Any of various conventional web browsers can be used to display and manipulate data on web pages.

Additionally, one or more application programs 119 used by the computing device 101, according to an illustrative embodiment, may include computer executable instructions for invoking user functionality related to communication including, for example, email, short message service (SMS), and voice input and speech recognition applications.

Embodiments of the disclosure may include forms of computer-readable media. Computer-readable media include any available media that can be accessed by a computing device 101. Computer-readable media may comprise storage media and communication media and in some examples may be non-transitory. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of the method steps disclosed herein may be executed on a processor on a computing device 101. Such a processor may execute computer-executable instructions stored on a computer-readable medium.

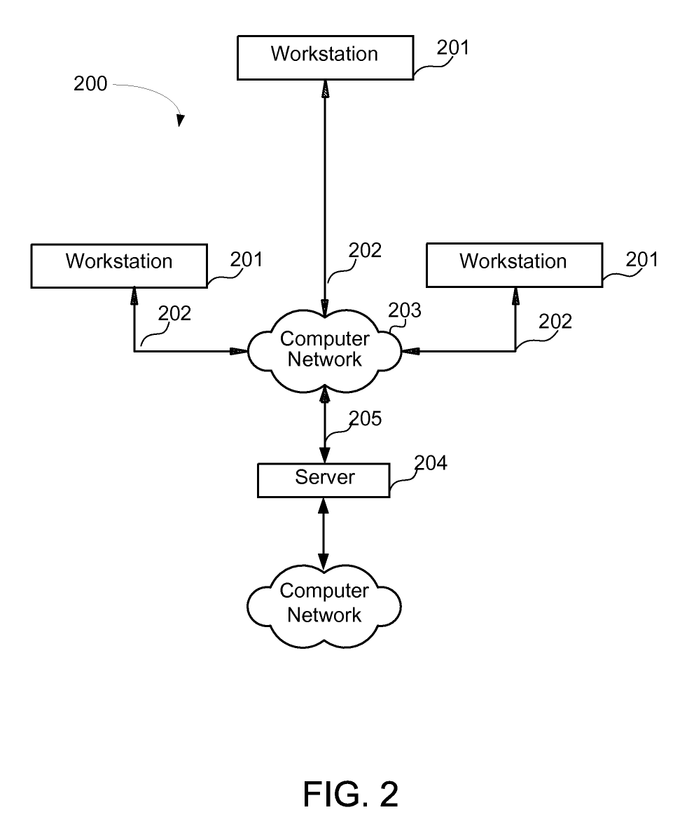

Referring to FIG. 2, an illustrative system 200 for implementing example embodiments according to the present disclosure is shown. As illustrated, system 200 may include one or more workstation computers 201. Workstations 201 may be local or remote, and may be connected by one of communications links 202 to computer network 203 that is linked via communications links 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204, such as network links, dial-up links, wireless links, hard-wired links, etc.

The steps that follow in the Figures may be implemented by one or more of the components in FIGS. 1 and 2 and/or other components, including other computing devices.

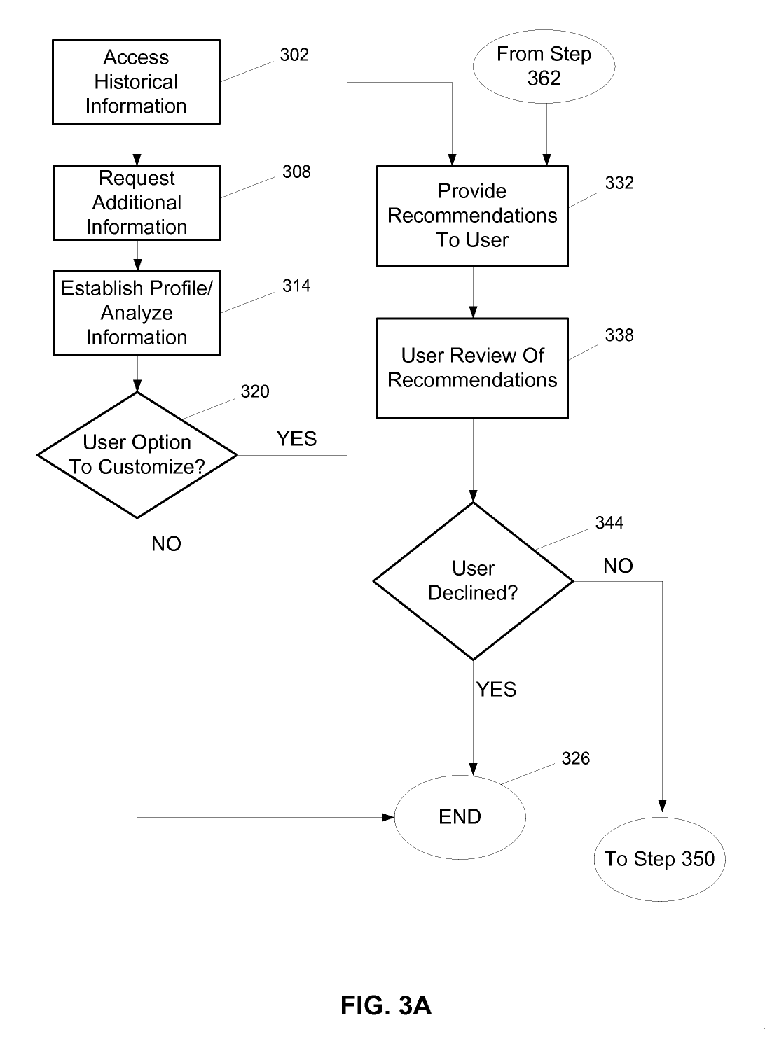

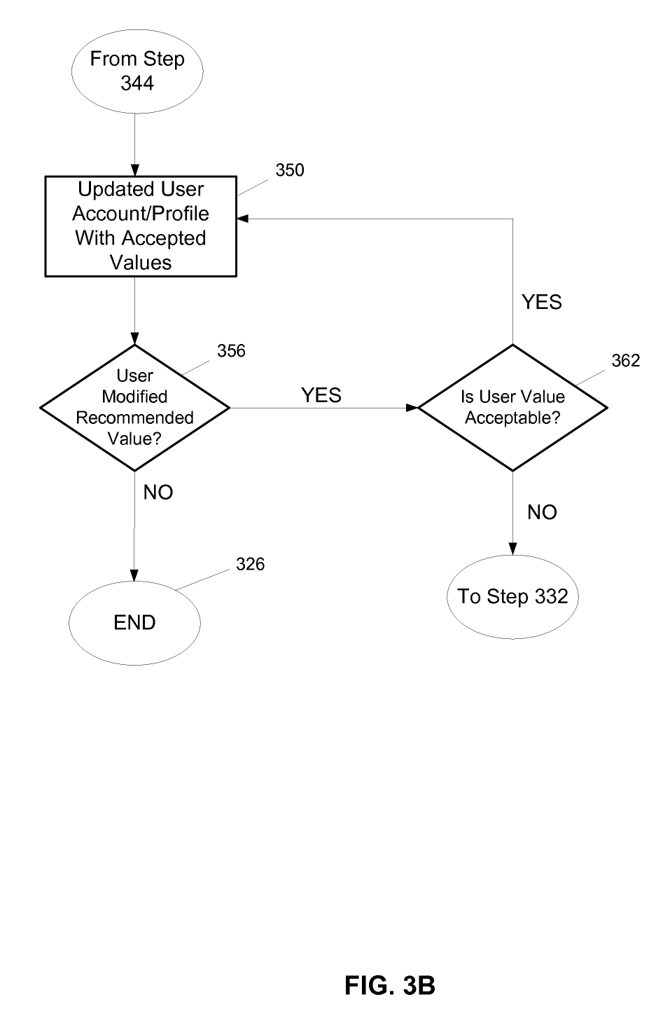

FIGS. 3A-3B (collectively referred to as FIG. 3) depict a method that may be used to illustrate one or more aspects of this disclosure. The method of FIG. 3 may be operative in one or more environments and/or on one or more computing devices (e.g., the environments and architectures shown in FIGS. 1-2).

In some embodiments, a user may be interested in customizing his/her account with a bank. The account may include one or more product or service offerings, such as support for debit/credit card transactions, checking, bill pay, savings, online banking, and the like. The bank may have access to historical activities in which the user has engaged. For example, the bank may store in a database or other memory device data on historical acquisitions, purchases, spending patterns, browsing activity, etc. for each user. In step 302 of FIG. 3, the bank may access or obtain historical information regarding the user and/or the user's account.

In step 308, the bank may request that the user disclose additional information in order to increase the amount of information to which the bank has access. The request may take the form of a survey, an application, or the like. The request may be administered via one or more web sites or the like. In some embodiments, the information may be protected via an authorization credential (e.g., a username and password, a PIN, etc.) in order to ensure that the user's privacy is maintained.

In step 314, the bank may establish a profile or the like for the user, based at least in part on the provided or accessed information associated with step 302 and/or step 308. Based on the profile or the information, the bank may engage in an analysis. The analysis may include assigning a score or other such indication (e.g., a risk level) to the user. The assigned score or indication may include an assessment of risk or liability that the user represents to the bank. For example, if a user routinely pays his/her credit card balance on time, that user may be allocated a low-risk score. Conversely, if the user is frequently late in paying his/her credit card balances, bounces checks, or has a history of defaulting on loans, then the user may be allocated a high-risk score. The information associated with step 302 and/or step 308 may be examined (e.g., combined, averaged, weighted, etc.) in order to formulate an overview of a user. In some embodiments, a profile of a typical, average, or reference user may be established, and scores for a user under consideration may be established by comparing the profile of the user under consideration to the profile of the reference user. In this manner, comparisons may be made across or between users on a consistent basis.

In some embodiments, the profile or risk assessment associated with step 314 may be modified, updated, or changed over time. As additional information is obtained with respect to the user, the bank may change its risk assessment of the user. For example, if the user is late on a payment, or otherwise does not comply with a term or condition associated with his/her account, the profile or risk assessment of the user may be updated to reflect that the user represents an increased risk to the bank relative to the previous perspective the bank held with respect to the user.

In step 320, a determination may be made whether a particular user should be provided an option of customizing terms or conditions associated with his/her account. For example, if an allocated risk score associated with step 314 indicates that the user represents a high-risk to the bank (e.g., the risk score is above a threshold value), then the user might not be presented with an option to customize terms/conditions, and the method may end (the “NO” path may be taken out of step 320 and flow may proceed to step 326). On the other hand, if an allocated risk score associated with step 314 indicates that the user represents a low-risk to the bank (e.g., the risk score is below a threshold value), then the user may be presented with an option to customize terms/conditions associated with his/her account with the bank (the “YES” path may be taken out of step 320 and flow may proceed to step 332). More generally, the bank may make a determination in step 320 whether to extend an option to the user to customize his/her account based at least in part on the information that the bank has with respect to a user, the number of accounts the bank currently holds, anticipated changes in market conditions, any combination of this information, or any other number of factors or considerations.

In step 332, the bank may provide the user with recommendations or suggestions. The recommendations or suggestions may relate to terms or conditions to be associated with an account that the user has with the bank. For example, the bank may offer the user suggestions regarding a percentage rate (e.g., annual percentage rate (APR)), rewards and reward rates, fees (e.g., annual service fees, checking fees, credit/debit card fees), cash back options, and the like. In some embodiments, a range of values associated with the recommendations or suggestions may be provided. For example, the user may be provided an opportunity to select a percentage rate in the range of 4% to 7%, which may be associated with a corresponding range of $250 to $0 in terms of a service fee assessed against the user's account. The recommendations or suggestions may be provided via one or more mechanisms. For example, the recommendations or suggestions may be delivered in a printed form (e.g., via the mail along with a regular statement), in response to a user logging-in to a website associated or affiliated with the bank, via a message (e.g., an email, a text, an instant, or a voice message), etc.

In some embodiments, a user may be presented with options to trade one or more benefits for one or more other benefits. For example, if the user selects a lower percentage rate, the user may incur a fee. As yet another illustrative example, one or more of an APR and annual fee may be tied to rewards points (e.g., a higher fee/APR may result in an opportunity or ability to earn more rewards points).

In step 338, the user may review the recommendations and suggestions provided in connection with step 332. In this regard, the user may be presented with new (business) opportunities of which the user might not otherwise have been aware. For example, the user may take advantage of a lower APR included in the recommendations/suggestions to purchase or finance a new service or product (e.g., a computer). As part of step 338, a user may furnish credentials (e.g., log-in information, a username and password, a PIN, etc.) in order to ensure that privacy considerations are maintained and that unauthorized actions are not taken against a user's account. As part of step 338, the bank may receive responses from the user in connection with the review conducted by the user. The response(s) may be received in a printed form (e.g., via the mail), via a website submission, via a message (e.g., an email, a text, an instant, or a voice message), etc. In connection with the review of step 338, the user may accept or decline/reject one or more of the suggestions/recommendations as described further below, and a notification to this effect may be received at the bank.

In step 344, a determination may be made whether the user declined to accept the recommendations/suggestions. If the user declined to accept the recommendations/suggestions (e.g., the “YES” path is taken out of step 344), the user's account or profile may remain as is (e.g., no update may take place with respect to the user's account or profile) and the flow may end at step 326. In some embodiments, the user's action of declining the recommendations/suggestions may be received and recorded or noted by the bank, possibly for future use or reference. In some embodiments, a user may be presented an option to withdraw from the recommendation/suggestion program so as to not be bothered by the recommendations/suggestions. Also, the user may be able to set a frequency (e.g., monthly) by which the user wants to receive recommendations/suggestions.

If the user accepted one or more of the recommendations/suggestions (e.g., the “NO” path is taken out of step 344), then flow may proceed to step 350. In step 350, the bank may update the user's account or profile. For example, the terms and conditions associated with the user's account with the bank may be updated to incorporate values included in the recommendations/suggestions provided to the user in step 332.

In step 356, a determination may be made whether the user's response associated with step 338 indicates that the user requested a modification to one or more values included in the suggestions/recommendations. For example, the user may have requested and specified a lower APR relative to what the bank had offered via the recommendations/suggestions provided in step 332. If the user did not a request a modification to one or more of the values (e.g., the “NO” path is taken out of step 356), then the flow may end (step 326).

If the user requested a modification to one or more of the values included in a recommendation/suggestion (e.g., the “YES” path is taken out of step 356), then the flow may proceed to step 362. For example, the “YES” path may be taken out of step 356 if the user requested a value that was outside of a range of values that may have been provided in connection with step 332. In step 362, the bank may determine whether a (modified) value requested or specified by the user is acceptable. If the value requested or specified by the user is acceptable (e.g., the “YES” path is taken out of step 362), then the flow may proceed to step 350 in order to incorporate that accepted value in the user's account/profile.

In some embodiments, the determination that may be made in step 362 regarding whether a modification to one or more of the values is acceptable may be based on a profile or risk assessment made in connection with step 314. For example, a high risk user may only be able to adjust a limited subset of terms/conditions associated with an account, a medium risk user may be able to adjust some but not all of the terms/conditions associated with an account, and a low risk user may be able to adjust any of the account terms/conditions.

If the value requested or specified by the user is not acceptable (e.g., the “NO” path is taken out of step 362), then flow may proceed to step 332. As part of the transition from step 362 to step 332, the bank may revise the recommendations/suggestions provided to the user relative to the preceding recommendations/suggestions provided to the user. For example, the bank may attempt to provide a recommendation/suggestion incorporating the value requested by the user, possibly altering values for other terms or conditions in the process. In this respect, the flow from step 332 to step 362 may execute iteratively/repeatedly and may be analogized to a negotiation between the user and the bank (incorporating elements of an offer, an acceptance, and/or a counter-offer).

The method described above in connection with FIG. 3 is illustrative. In some embodiments, one or more of the steps (or portions thereof) may execute in an order different from that shown. In some embodiments, one or more of the steps may be optional. In some embodiments, one or more steps not shown may be included.

In some embodiments, the bank may acquire information related to a user's networking activity, such as the user's networking status, history, or behavior. For example, in connection with one or more of steps 302, 308, and 314, the bank may analyze a user's social networking history to determine whether the user should be provided an option to customize the account (e.g., step 320), and what terms or conditions should be applied or recommended.

In some embodiments, the method of FIG. 3 may execute to provide for an adaptive model. For example, an execution or iteration of the method of FIG. 3 may occur in response to a change in one or more inputs (e.g., a user changing his/her social network account in some manner, such as becoming a “friend” of a particular person, the user searching for and/or browsing on a particular website, a change in market conditions, etc.). In some embodiments, an execution or iteration of the method may occur due to the passage of time. For example, the method may execute periodically in an effort to ensure continued user satisfaction.

The method of FIG. 3 may be used to customize a user account. In this regard, a user may exercise greater control over his/her account relative to conventional systems and processes, allowing the user to tailor his/her account to his/her needs and/or preferences. Based at least in part on such customization, the user and/or the bank may be exposed to, or gain access to, additional business opportunities that the user and/or the bank might not otherwise be aware of.

Aspects of the disclosure may enable, e.g., a bank to reach out to existing customers or clients and suggest products or services that better meet their evolving needs. This logic could be based on one or more of a better or more up-to-date understanding of a credit profile, a review of purchase patterns (e.g., recent purchase patterns), or a review of tendencies in revolving a balance, etc.

Aspects of this disclosure may readily be applied to, and adapted to be operative on, one or more communication systems. Those communication systems may include computer networks, television networks, satellite networks, telephone and cellular networks, and the like.

Although not required, various aspects described herein may be embodied as a method, a data processing system, and/or as a transitory and/or non-transitory computer-readable medium storing executable instructions. Accordingly, those aspects may take the form of an entirely hardware embodiment, an entirely software embodiment, an entirely firmware embodiment, or an embodiment combining software, firmware and hardware aspects. The functionality may be resident in a single computing device, or may be distributed across multiple computing devices/platforms, the multiple computing devices/platforms optionally being connected to one another via one or more networks. Moreover, the structural components described herein may be distributed amongst one or more devices, optionally within a common housing or casing.

Various signals representing content, data, information, or events as described herein may be transferred between a source and a destination in the form of electromagnetic waves traveling through signal-conducting media such as metal wires, optical fibers, and/or wireless transmission media (e.g., air and/or space).

The various methods and acts may be operative across one or more computing servers, databases, and one or more networks. The functionality may be distributed in any manner, or may be located in a single computing device (e.g., a server, a database, a client computer, etc.). As discussed herein, content (e.g., recommendations/suggestions for terms and conditions to be associated with a user account, and any modifications thereof) may be distributed to intermediary/network components and client-side devices at various times and in various formats. The distribution and transmission techniques described herein may leverage existing components and infrastructure to minimize power dissipation, operational complexity, footprint size, and management involvement, amongst other factors and costs.

The methodological acts and processes described herein may be tied to particular machines or apparatuses. For example, one or more product or service offerings may be transmitted to a user device or location via one or more computing devices (e.g., servers) and the offer(s) may be displayed at the user location via one or more terminals and/or display devices. One or more acceptances, rejections, and/or counter-offers may be transmitted from a user device or location to one or more computing devices (e.g., servers). In some embodiments, (additional or supplemental) information regarding a user may be transmitted from a user device or location to one or more computing devices (e.g., servers). More generally, one or more computers may include one or more processors and memory storing instructions, that when executed, perform the methodological acts and processes described herein. Furthermore, the methodological acts and processes described herein may perform a variety of functions including transforming an article (e.g., a user account or profile associated with baseline or standard values in regards to terms and conditions) into a different state or thing (e.g., a customized user profile or account based at least in part on values included in suggestions/recommendations and modifications thereto).

Aspects of the disclosure have been described in terms of illustrative embodiments thereof Numerous other embodiments, modifications and variations within the scope and spirit of the appended claims will occur to persons of ordinary skill in the art from a review of this disclosure. For example, one of ordinary skill in the art will appreciate that the steps illustrated in the figures may be performed in other than the recited order, and that one or more steps illustrated may be optional in accordance with aspects of the disclosure.

What is claimed is:

1. An apparatus comprising:
at least one processor; and
memory storing instructions that, when executed by the at least one processor, cause the apparatus at least to:
access historical information associated with a user account,
determine, based on an analysis of the historical information, that customization of the account is permitted, and
transmit a recommendation comprising a suggested value to be associated with the account.

2. The apparatus of claim 1, wherein the instructions, when executed by the at least one processor, cause the apparatus to:
receive a response based at least in part on the recommendation.

3. The apparatus of claim 2, wherein the response comprises an acceptance of the recommendation, and wherein the instructions, when executed by the at least one processor, cause the apparatus to:
update the account with the suggested value.

4. The apparatus of claim 2, wherein the recommendation comprises a second suggested value, and wherein the response comprises a modified value for the second suggested value.

5. The apparatus of claim 4, wherein the instructions, when executed by the at least one processor, cause the apparatus to:
determine that the modified value for the second suggested value is acceptable, and
update the account with the modified value.

6. A method comprising:
accessing historical information associated with a user account;
analyzing the historical information;
determining, by a server, that customization of the account is permitted based at least in part on the analysis; and
transmitting, from the server, a recommendation comprising a suggested value to be associated with the account.

7. The method of claim 6, further comprising:
receiving a response based at least in part on the recommendation.

8. The method of claim 7, wherein the response comprises a rejection of the recommendation, the method further comprising:
recording the rejection at the server.

9. The method of claim 7, wherein the response comprises an acceptance of the recommendation, the method further comprising:
updating the account with the suggested value.

10. The method of claim 7, wherein the recommendation comprises a second suggested value, and wherein the response comprises a modified value for the second suggested value.

11. The method of claim 10, further comprising:
determining that the modified value for the second suggested value is acceptable; and
updating the account with the modified value.

12. The method of claim 10, further comprising:
determining that the modified value for the second suggested value is unacceptable; and
transmitting a second recommendation comprising the modified value for the second suggested value and a different value for the suggested value.

13. The method of claim 6, wherein the suggested value is associated with at least one of a percentage rate, rewards and reward rates, fees, and cash back options.

14. The method of claim 6, further comprising:
transmitting a request for additional information;
receiving additional information in response to the request; and
analyzing the received additional information,
wherein the determination that customization of the account is permitted is further based on the analyzed additional information.

15. The method of claim 6, further comprising:
receiving at the server at least one authorization credential associated with the user account,
wherein the recommendation is transmitted responsive to validating the received authorization credential.

16. A method comprising:
processing, by a processor, information to categorize a user into a particular one of a plurality of risk levels;
identifying a first term and a second term of an account based on the particular risk level;
processing selection data from the user assigning a value to the first term; and
determining a value for the second term based on the value assigned to the first term.

17. The method of claim 16, further comprising:
transmitting a request for additional information;
receiving additional information in response to the request;
analyzing the received additional information; and
determining that the value assigned to the first term is acceptable based at least in part on the analyzed additional information.

18. The method of claim 16, wherein the information comprises historical acquisitions, purchases, spending patterns, and browsing activity.

19. The method of claim 16, wherein the selection data is received via at least one of a website submission, an email, a text message, an instant message, and a voice message.

20. The method of claim 16, wherein the information comprises social networking activity of the user.
